(19) United States
(12) Patent Application Publication
(10) Pub. No.: US 2026/0254571 A1
(43) Pub. Date: Aug. 27, 2026

(54) TRANSMISSION SYSTEM OF BASE STATION, RADIO TERMINAL, DISTRIBUTED UNIT OF BASE STATION, AND METHODS THEREFOR

(71) Applicant: NEC Corporation, Minato-ku, Tokyo (JP)

(72) Inventors: Kazushi MURAOKA, Tokyo (JP); Toshiki TAKEUCHI, Tokyo (JP); Yasushi MARUTA, Tokyo (JP)

(73) Assignee: NEC Corporation, Minato-ku, Tokyo (JP)

(21) Appl. No.: 18/994,200

(22) PCT Filed: Aug. 29, 2023
(86) PCT No.: PCT/JP2023/031349

§ 371 Date: Jan. 14, 2025

(30) Foreign Application Priority Data
Sep. 9, 2022 (JP) 2022-143672

(51) Int. Cl. H04L 5/00; H04B 7/06; H04L 27/26

(52) U.S. Cl. CPC H04L 5/0005; H04B 7/06952; H04L 27/261

(57) ABSTRACT

A transmission system of a base station transmits a first demodulation reference signal used to demodulate a same set or one of different sets of modulation symbols generated from a same broadcast channel payload or from different broadcast channel payloads, from each of a plurality of transmission points, in a separate first set of time and frequency resources per transmission point. In addition, the transmission system transmits the same set of modulation symbols or the different sets of modulation symbols from the plurality of transmission points in the same second set of time and frequency resources.

### TECHNICAL FIELD

The present disclosure relates to a wireless communication system, in particular, to a beam sweep transmission of a broadcast signal by a base station.

### BACKGROUND ART

3rd Generation Partnership Project (3GPP (registered trademark)) Fifth Generation (5G) systems use beam sweeping to allow a User Equipment (UE) to select the best beam during initial access. Specifically, a gNB transmits multiple Synchronization Signal (SS)/Physical Broadcast Channel (PBCH) blocks (SSBs) as a burst, changing the beam direction each time an SSB is transmitted at a fixed periodicity. Each SSB contains a Primary Synchronization Signal (PSS), a Secondary Synchronization Signal (SSS), a PBCH, and PBCH Demodulation Reference Signals (DMRS).

A single SSB is spread over four consecutive Orthogonal Frequency Division Multiplexing (OFDM) symbols in the time domain and 240 consecutive subcarriers (i.e., 20 resource blocks) in the frequency domain. SSBs within a burst correspond to individual beams and are beam-formed in different directions. A set of SSBs within a burst is called an SSB burst set and is transmitted in a half radio frame, a window of 5 milliseconds (ms). An SSB burst set (i.e., 5 ms duration) is typically repeated at a periodicity of 2 radio frames, or 20 ms. In order to achieve a trade-off between coverage and resource overhead, the maximum number of SSBs within an SSB burst set (i.e., 5 ms duration) is defined as 4 for frequency bands up to 3 GHZ, 8 for 3 to 6 GHZ, and 64 for 6 to 52.6 GHz. The number of SSBs actually transmitted within a cell is configurable and may be less than the maximum.

Each SSB within a single SSB burst set (5 ms) is assigned a unique SSB index numbered from 0 increasing by 1. If the maximum number of candidate SSBs that can be transmitted within an SSB burst set is 64, the SSB index is communicated to the UE via two parts within an SSB. The SSB index is divided into two fields, with the first field transmitted as part of the PBCH payload and the second part of the SSB index transmitted as part of the PBCH DMRS sequence.

In a case where a UE synchronizes with a wireless access network and performs an initial access, it is required to read an SSB. In the idle mode, i.e., Radio Resource Control (RRC)_IDLE or RRC_INACTIVE, the UE searches for SSBs being transmitted in a cell, receives an SSB burst set, and selects an SSB with the best reception quality, i.e., the best beam. The SSB indexes are mapped to available Random Access Channel (RACH) occasions. The UE notifies the network, i.e., a gNB, of the SSB beam selected by the UE by transmitting a Physical RACH (PRACH) preamble on the RACH occasion associated with the selected best beam.

For example, the 5G specifications for SSB beam sweeping provided by 3GPP can be found in Non-Patent Literature 1-4.

### CITATION LIST

### Non Patent Literature

[Non-Patent Literature 1] 3GPP TS 38.211 V17.2.0 (2022 June), “3rd Generation Partnership Project; Technical Specification Group Radio Access Network; NR; Physical channels and modulation (Release 17)”, June 2022
[Non-Patent Literature 2] 3GPP TS 38.212 V17.2.0 (2022 June), “3rd Generation Partnership Project; Technical Specification Group Radio Access Network; NR; Multiplexing and channel coding (Release 17)”, June 2022
[Non-Patent Literature 3] 3GPP TS 38.213 V17.2.0 (2022 June), “3rd Generation Partnership Project; Technical Specification Group Radio Access Network; NR; Physical layer procedures for control (Release 17)”, June 2022
[Non-Patent Literature 4] 3GPP TS 38.331 V17.1.0 (2022 June), “3rd Generation Partnership Project; Technical Specification Group Radio Access Network; NR; Radio Resource Control (RRC) protocol specification (Release 17)”, July 2022

### SUMMARY OF INVENTION

### Technical Problem

The inventors anticipate that 5G system enhancements, or future 6G or later systems, will use millimeter-wave or sub-terahertz frequencies and employ a deployment of multiple Transmission Reception Points (TRPs) that are geographically dispersed and have overlapping coverage areas to achieve site diversity effects. A TRP hosts one or more antenna elements (typically an array antenna) and radio frequency (RF) components, and can communicate with UEs using beams. A TRP may also be referred to as a radio unit (RU), remote radio head (RRH), access point, or distributed antenna. In a case where only downlink transmissions (e.g., SSB transmission) from a base station are considered, a TRP may also be referred to as a transmission point.

However, if a large number of TRPs are used in a single cell and the number of beams transmitted within that cell increases, the current maximum number of candidate SSB beams of 64 may not be sufficient. If all of the SSB beams transmitted in a cell are swept with different time resources or OFDM symbols, then the current constraints on either or both the SSB burst periodicity (i.e., 20 ms) and the SSB burst duration (i.e., 5 ms) may need to be relaxed in order to increase the maximum number of candidate SSB beams to beyond 64. Specifically, it may be necessary to shorten the SSB burst periodicity or lengthen the duration of the SSB burst set, or both. These would increase the overhead of SSB transmission (i.e., beam sweep transmission).

To address this issue, the inventors considered an architecture that would allow multiple TRPs to transmit SSB beams simultaneously in the same time resources or OFDM symbols. This will reduce the amount of radio resources required to transmit different SSB beams, thus helping to reduce the overhead of SSB transmission (i.e., beam sweep transmission). However, the inventors found several problems with this architecture. One of these problems relates to the measurement of the received power or quality of each SSB beam by UEs. Another of these problems relates to the identification of beams or SSBs by UEs.

In an implementation, multiple TRPs transmit sets of different PBCH modulation symbols generated from different PBCH payloads over the same time and frequency resources, i.e., resource elements. In this implementation, a UE may receive SSB transmissions from multiple TRPs simultaneously, depending on the location of the UE, but the UE may be able to demodulate the PBCH of a received SSB with higher power. However, interference between SSB beams may make it difficult for the UE to measure the received power or quality of each SSB beam.

In another implementation, multiple TRPs transmit sets of different PBCH modulation symbols generated from the same BCH payload over the same time and frequency resources, i.e., resource elements. Even in this implementation, a UE may receive SSB transmissions from multiple TRPs simultaneously, depending on the location of the UE, but the UE may be able to demodulate the PBCH of a received SSB with higher power. However, even in this implementation, interference between SSB beams may make it difficult for the UE to measure the received power or quality of each SSB beam. In addition, in this implementation, the bits within the same PBCH payload cannot distinguish or identify the multiple beams or SSBs transmitted by the multiple TRPs over the same time and frequency resources. Therefore, additional measures may be required to enable UEs to uniquely identify each of these multiple beams or SSBs.

In yet another implementation, multiple TRPs transmit the same PBCH modulation symbols generated from the same PBCH payload over the same time and frequency resources, i.e., resource elements. Again, in this example, the problem is that it becomes difficult for UEs to measure the received power or quality of each SSB beam due to interference between SSB beams. In addition, additional measures may be required to enable UEs to uniquely identify each of the multiple beams or SSBs transmitted by the multiple TRPs over the same time and frequency resources.

One of the objects to be achieved by the example embodiments disclosed herein seek to achieve is to provide apparatuses, methods, and programs that contribute to solving at least one of a plurality of problems, including the problems described above. It should be noted that this object is only one of the objects to be achieved by the example embodiments disclosed herein. Other objects or problems and novel features will become apparent from the following description and the accompanying drawings.

### Solution to Problem

In a first aspect, a transmission system of a base station includes a plurality of transmission points and a baseband unit. The baseband unit is configured to control each of the plurality of transmission points to transmit a first demodulation reference signal used to demodulate a same set or one of different sets of modulation symbols generated from a same broadcast channel payload or from different broadcast channel payloads, in a separate first set of time and frequency resources per transmission point. The baseband unit is further configured to control the plurality of transmission points to transmit the same set of modulation symbols or the different sets of modulation symbols in a same second set of time and frequency resources.

In a second aspect, a method performed by a transmission system of a base station includes the steps of:
(a) transmitting a first demodulation reference signal used to demodulate a same set or one of different sets of modulation symbols generated from a same broadcast channel payload or from different broadcast channel payloads, from each of a plurality of transmission points, in a separate first set of time and frequency resources per transmission point; and
(b) transmitting the same set of modulation symbols or the different sets of modulation symbols from the plurality of transmission points in a same second set of time and frequency resources.

In a third aspect, a radio terminal includes an RF circuit configured to communicate with a radio access network and at least one processor. The at least one processor is configured to control the RF circuit to receive, in a separate first set of time and frequency resources per transmission point, a first demodulation reference signal used to demodulate a same set or one of different sets of modulation symbols generated from a same broadcast channel payload or from different broadcast channel payloads. The at least one processor is further configured to control the RF circuit to receive, in a second set of time and frequency resources common to a plurality of transmission points, the same set of modulation symbols or one of the different sets of modulation symbols.

In a fourth aspect, a method performed by a radio terminal includes the steps of:
(a) receiving, in a separate first set of time and frequency resources per transmission point, a first demodulation reference signal used to demodulate a same set or one of different sets of modulation symbols generated from a same broadcast channel payload or from different broadcast channel payloads; and
(b) receiving, in a second set of time and frequency resources common to a plurality of transmission points, the same set of modulation symbols or one of the different sets of modulation symbols.

In a fifth aspect, a radio terminal includes an RF circuit configured to communicate with a radio access network and at least one processor. The at least one processor is configured to control the RF circuit to receive a demodulation reference signal used to demodulate a broadcast channel. The demodulation reference signal is transmitted in a first set of time and frequency resources that are dedicatedly assigned per transmission point, and the broadcast channel is transmitted by a plurality of transmission points in a same second set of time and frequency resources. The at least one processor is further configured to determine, based at least on a location within a resource grid of a time and frequency resource at which the demodulated reference signal is received, a portion of an identifier or index for distinguishing between a plurality of beams or a plurality of synchronization signal and physical broadcast channel blocks transmitted from the plurality of transmission points.

In a sixth aspect, a method performed by a radio terminal includes the steps of:
(a) receiving a demodulation reference signal used to demodulate a broadcast channel, wherein the demodulation reference signal is transmitted in a first set of time and frequency resources that are dedicatedly assigned per transmission point, and the broadcast channel is transmitted by a plurality of transmission points in a same second set of time and frequency resources; and
(b) determining, based at least on a location within a resource grid of a time and frequency resource at which the demodulated reference signal is received, a portion of an identifier or index for distinguishing between a plurality of beams or a plurality of synchronization signal and physical broadcast channel blocks transmitted from the plurality of transmission points.

A seventh aspect is directed to a program. The program includes a set of instructions (software code) that, when loaded into a computer, cause the computer to perform the method according to the second, fourth, or sixth aspect described above.

### Advantageous Effects of Invention

According to the aspects described above, it is possible to provide apparatuses, methods, and programs that contribute to solving at least one of a plurality of problems related to sending and receiving broadcast signals, including the problems mentioned above.

### BRIEF DESCRIPTION OF DRAWINGS

FIG. 1 shows an example configuration of a radio communication system in an example embodiment;

FIG. 2 shows an example configuration of a transmission system of a base station in an example embodiment;

FIG. 3 shows an example configuration of a transmission system of a base station in an example embodiment;

FIG. 4 is a flowchart showing an example of the operation of a base station in an example embodiment;

FIG. 5 is a diagram illustrating an example of transmitting multiple SSBs in an example embodiment;

FIG. 6 shows an example of the mapping of TRP-specific PBCH DMRS in an SSB in an example embodiment;

FIG. 7 shows an example of the mapping of TRP-specific PBCH DMRS in an SSB in an example embodiment;

FIG. 8 is a flowchart showing an example of the operation of a base station in an example embodiment;

FIG. 9 shows an example configuration of a UE in an example embodiment;

FIG. 10 is a flowchart showing an example of the operation of a UE in an example embodiment;

FIG. 11 shows an example of the mapping of TRP-specific PBCH DMRS and common PBCH DMRS in an SSB in an example embodiment;

FIG. 12 is a sequence diagram showing an example of signaling between a base station and a UE in an example embodiment;

FIG. 13 is a flowchart showing an example of the operation of a UE in an example embodiment;

FIG. 14 shows an example configuration of a TRP in an example embodiment;

FIG. 15 is a diagram illustrating an example of transmitting multiple SSBs in an example embodiment;

FIG. 16 is a block diagram showing an example configuration of a CU and a DU in an example embodiment;

FIG. 17 is a block diagram showing an example configuration of a TRP in an example embodiment; and

FIG. 18 is a block diagram showing an example configuration of a UE in an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to 3GPP 5G systems. However, these embodiments can also be applied to other radio communication systems that support beam sweeping techniques similar to SSB beam sweeping in 3GPP 5G systems.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

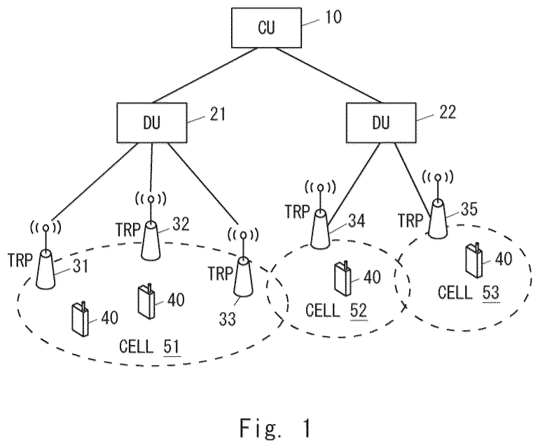

First, the configuration and operation of a plurality of network elements common to a plurality of example embodiments are described. FIG. 1 shows an example configuration of a radio communication system according to a plurality of example embodiments. In the example of FIG. 1, the radio communication system includes a Central Unit (CU) 10, Distributed Units (DUs) 21 and 22, TRPs 31 to 35, and UEs 40. The UEs 40 may also be referred to by other terms such as radio terminals, mobile terminals, mobile stations, or wireless transmit receive units (WTRUs). Each element (or network function) shown in FIG. 1 can be implemented, for example, as a network element on dedicated hardware, as a software instance running on dedicated hardware, or as a virtualized function instantiated on an application platform.

The CU 10, the DUs 21 and 22, and the TRPs 31 to 35 correspond to a single base station. In other words, a single base station includes the CU 10, the DUs 21 and 22, and the TRPs 31 to 35. A base station may be referred to as a radio access network node, a radio station, or an access point. In the case of a 5G system, a base station may be a gNB.

The CU 10 may host the RRC, Service Data Adaptation Protocol (SDAP), and Packet Data Convergence Protocol (PDCP) protocols of a gNB (or the RRC and PDCP protocols of a gNB). The CU 10 may contain a Control Plane (CP) unit (e.g., gNB-CU-CP) and one or more User Plane (UP) units (e.g., gNB-CU-UPs).

Each of the DUs 21 and 22 hosts the Radio Link Control (RLC) and Medium Access Control (MAC) layers of a gNB, and may also host part or all of the Physical (PHY) layer of a gNB. In cases where each of the DUs 21 and 22 hosts a part of the PHY layer, namely the high PHY layer, the remaining PHY layer signal processing, namely the low PHY layer, is placed in the TRPs 31 to 35. In the example shown in FIG. 1, the DU 21 is connected to the TRPs 31 to 33, while the DU 22 is connected to the TRPs 34 and 35. The TRPs 31 to 33 provide a single cell 51, while the TRPs 34 and 35 provide different cells 52 and 53, respectively. In other words, the DU 21 provides a single cell 51, and the TRPs 31 to 33 correspond to the cell 51. The DU 22 provides multiple cells 52 and 53, and the TRPs 34 and 35 correspond to the cells 52 and 53, respectively.

Each of the TRPs 31 to 35 can communicate with the UEs 40 using beams. The TRPs 31 to 35 may be referred to as Radio Units (RUs), Remote Radio Heads (RRHs), access points (APs), or distributed antennas. In a case where only downlink transmission (e.g., SSB transmission) by the base station is considered, each TRP may be referred to as a transmission point.

Each of the TRPs 31 to 35 provides analog RF signal processing. Each TRP may provide low PHY layer signal processing. Each TRP includes or is connected to one or more antenna elements (typically an array antenna). Each TRP includes RF components coupled to one or more antenna elements. For analog or hybrid beamforming, analog beamforming circuitry may be placed between one or more antenna elements or one or more array antennas and a plurality of RF chains of each TRP.

Each TRP may also include a digital front end (DFE). The DFE provides low PHY layer signal processing and digital radio signal processing. The low PHY signal processing includes, for example, inverse fast Fourier transform (IFFT) for OFDM signal generation and FFT for obtaining subcarrier signal components from received OFDM signals. The low PHY layer signal processing may also include Cyclic Prefix (CP) addition and removal, and may include Physical RACH (PRACH) extraction or filtering. The digital radio signal processing may include, for example, digital pre-distortion (DPD), crest factor reduction (CFR), digital up conversion (DUC), digital down conversion (DDC), and transmit/receive baseband channel filter. The DFE may perform digital baseband precoding for beamforming. For analog or hybrid beamforming, analog beamforming circuitry may be placed between one or more antenna elements or one or more array antennas and a plurality of RF chains of each TRP.

The DU 21 may be connected to each of the TRPs 31 to 33 via an interface that conforms to standard specifications such as the Common Public Radio Interface (CPRI), enhanced CPRI (eCPRI), and Open Radio Access Network (O-RAN) Fronthaul. Alternatively, the DU 21 may be connected to each of the TRPs 31 to 33 via an interface using Radio over Fiber (RoF) technology. In this case, the DU 21 may perform all digital signal processing, including high PHY layer and low PHY layer signal processing, as well as digital-to-analog (DA) and analog-to-digital (AD) conversion.

A direct interface, connection or backhaul may be provided to communicatively connect the DU 21 and the DU 22. Similarly, a direct interface, connection, or backhaul may be provided to communicatively connect TRPs within a cell or between cells, such as between TRPs 31 to 33, between TRPs 33 and 34, and between TRPs 34 and 35.

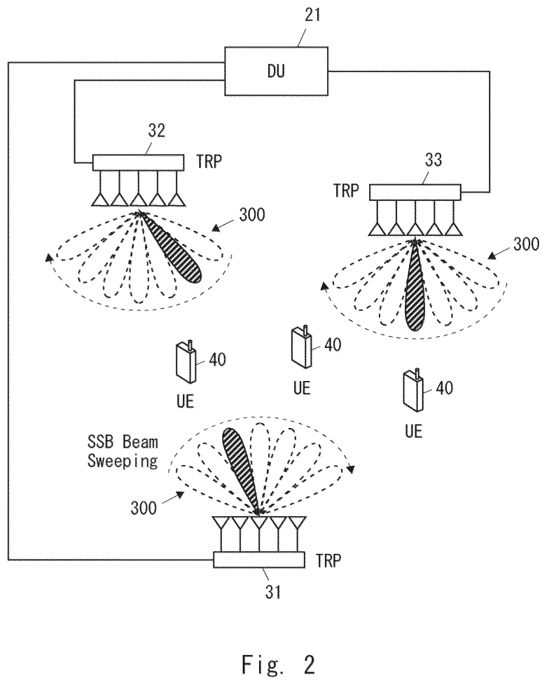

FIG. 2 conceptually shows the SSB beam sweep performed by the TRPs 31 to 33 in a single cell (cell 51). To allow UEs 40 to select the best beam for initial access, each of the TRPs 31 to 33 uses a beam sweep 300. Specifically, each TRP transmits multiple SSBs, changing the beam direction each time it transmits an SSB. Each SSB contains a PSS, an SSS, a PBCH, and PBCH DMRS. In a case where multiple TRPs are arranged in a single cell, at least one of these TRPs may transmit only one SSB beam. In other words, at least one of the multiple TRPs in the cell may intermittently transmit one SSB beam in a predetermined direction at a predetermined cycle without performing a beam sweep.

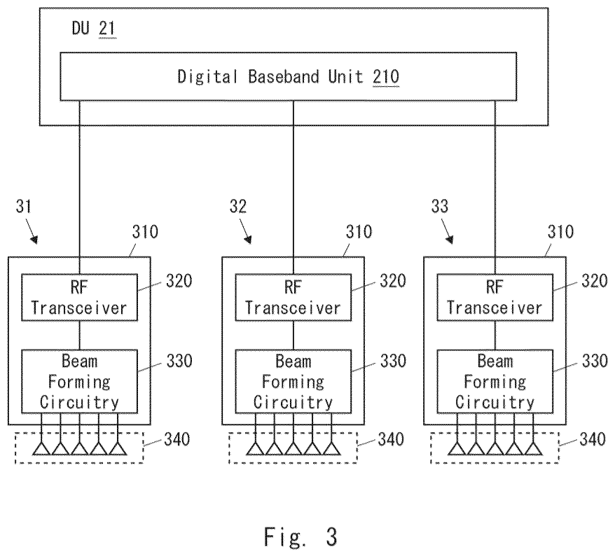

FIG. 3 shows an example configuration of the DU 21 and the TRPs 31 to 33 providing a single cell (cell 51). In the example shown in FIG. 3, the DU 21 includes a digital baseband unit 210. The digital baseband unit 210 provides signal processing for the RLC, MAC, and high PHY layers. With respect to SSB transmission, the digital baseband unit 210 generates a Broadcast Channel (BCH) transport block containing a Master Information Block (MIB) message, and then generates a PBCH payload containing that BCH transport block and additional timing-related PBCH payload bits. The digital baseband unit 210 also performs scrambling, cyclic redundancy check (CRC) bit addition, channel coding, and rate matching on the generated PBCH payload. Further, the digital baseband unit 210 performs scrambling on the block of bits after rate matching and maps the scrambled block of bits to multiple modulation symbols (e.g., complex-valued Quadrature Phase Shift Keying (QPSK) symbols).

Depending on the functional split between the DU 21 and the TRPs 31 to 33, the digital baseband unit 210 may perform all the digital signal processing, including the low PHY layer signal processing, as well as digital-to-analog (DA) and analog-to-digital (AD) conversion.

In the example shown in FIG. 3, each of the TRPs 31 to 33 includes an RF component 310. The RF component 310 is coupled to an antenna 340. In the example shown in FIG. 3, the antenna 340 includes a plurality of antenna elements and is typically an array antenna. The RF component 310 includes an RF transceiver 320 and beamforming circuitry 330. The RF transceiver 320 includes an amplifier and a frequency converter. The beamforming circuitry 330 determines the beam direction by adjusting one or both of the phase and the amplitude of the radio signal to be fed to the multiple antenna elements of the antenna 340. The specific beam direction or beam number, etc., is specified by the DU 21 or the CU 10. Other beamforming techniques may be used, and the antenna 340 may be a directional antenna, such as a lens antenna or a metamaterial antenna.

### First Example Embodiment

An example configuration of a radio communication system in this example embodiment may be the same as the example explained with reference to FIGS. 1 to 3. This example embodiment provides the operation of a base station and a UE with respect to beam sweep transmission and reception of SSBs.

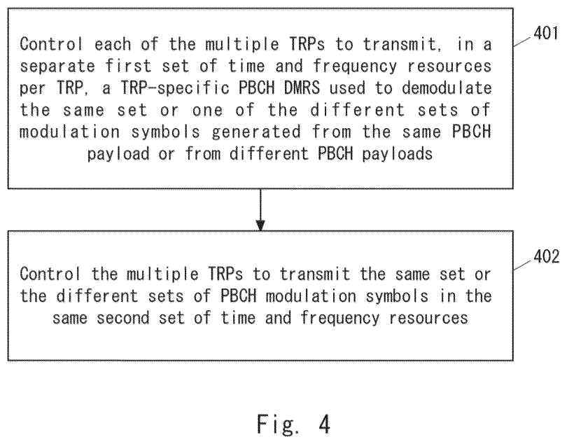

FIG. 4 shows an example of the operation of a transmission system of a base station for SSB transmission. The operation shown in FIG. 4 may be performed, for example, by the DU 21 connected to the TRPs 31 to 33 in a single cell (cell 51). The operation shown in FIG. 4 may be performed by the digital baseband unit 210 in the DU 21.

In step 401, the DU 21 controls each of the multiple TRPs 31-33 in the cell 51 to transmit a TRP-specific or dedicated PBCH DMRS in a separate first set of time and frequency resources per TRP. The TRP-specific PBCH DMRS is used by UEs 40 to demodulate the same set or one of the different sets of modulation symbols generated from the same PBCH payload or from different PBCH payloads. In other words, the transmission system of the base station transmits DMRS used to demodulate the same set or one of the different sets of modulation symbols generated from the same PBCH payload or from different PBCH payloads, from each of the multiple transmission points in a first set of time and frequency resources specific to each transmission point. The first set of time and frequency resources may be a set of resource elements.

In step 402, the DU 21 controls the TRPs 31 to 33 to transmit the same set or the different sets of PBCH modulation symbols in the same second set of time and frequency resources. In other words, the transmission system of the base station transmits the same set or the different sets of PBCH modulation symbols from the multiple transmission points in the same second set of time and frequency resources. The second set of time and frequency resources may be a set of resource elements.

The UE 40 receives the TRP-specific PBCH DMRS in the separate first set of time and frequency resources per TRP. In addition, the UE 40 receives the same set or the different sets of PBCH modulation symbols in the second set of time and frequency resources common to the multiple TRPs.

In some implementations, the UE 40 may estimate an individual channel response between each TRP and the UE 40 based on the reception of the TRP-specific PBCH DMRS, and may demodulate and decode the PBCH payload from one of the different sets of PBCH modulation symbols using the individual channel response. Depending on the location of the UE 40, the UE 40 may receive SSB transmissions from multiple TRPs simultaneously, but the UE 40 may be able to demodulate the PBCH payload of an SSB received at a higher power.

In other implementations, the UE 40 may estimate an individual channel response between each TRP and the UE 40 based on the reception of the TRP-specific PBCH DMRS, and calculate a composite channel response using multiple individual channel responses between multiple TRPs and the UE 40. The UE 40 may then demodulate and decode the same PBCH payload from the same set of PBCH modulation symbols using the composite channel response.

According to the operation described with reference to FIG. 4, multiple TRPs transmit multiple SSBs simultaneously in the same second set of time and frequency resources. This can help reduce the increase in the overhead of SSB transmission (i.e., beam sweep transmission). In addition, according to the operation described with reference to FIG. 4, the UE 40 can receive the TRP-specific PBCH DMRS in a separate first set of time and frequency resources per TRP. Thus, the UE 40 can measure the received power or quality of the TRP-specific PBCH DMRS in the separate first set of time and frequency resources for each TRP, and to obtain a measured value for each SSB beam. Accordingly, the operation of the base station transmission system and the UE 40 described with reference to FIG. 4 can contribute to reducing the difficulty of measuring the received power or quality of each SSB beam by UEs while suppressing the increase in the overhead of SSB transmission. The received power may be Reference Signal Received Power (RSRP). The received quality may be Reference Signal Received Quality (RSRQ) or Signal-to-Interference and Noise Ratio or Signal-to-Noise and Interference Ratio (SINR).

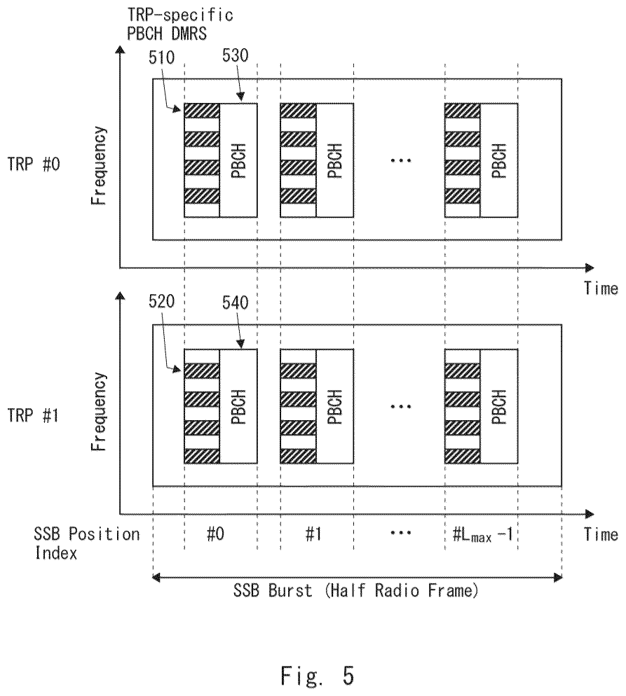

FIG. 5 shows an example of SSB transmission by two TRPs within a single SSB burst set. In the example shown in FIG. 5, the maximum number of candidate time domain locations where each TRP can transmit SSBs within a single SSB burst set is Lₘₐₓ. The number of SSBs actually transmitted by each TRP is configurable and may be less than the maximum. The two TRPs #0 and #1 share the same candidate time domain locations within the SSB burst set, and transmit PBCH 530 and PBCH 540 in the same time and frequency resources (resource elements). However, the two TRPs #0 and #1 transmit their respective TRP-specific PBCH DMRSs 510 and 520 in different time and frequency resources (resource elements) within each candidate time domain location. Each time domain location is a location in the time domain in the mapping of time and frequency resources (resource elements). The candidate time domain locations within an SSB burst set can also be referred to as the transmission occasions of SSBs within an SSB burst set.

For example, and not as a limitation, Lₘₐₓ can be 64, the same as in the current NR specifications. In addition, the duration of an SSB burst set can be half a radio frame, or 5 ms, the same as in the current NR specifications. Even in this case, in the example in FIG. 5, the two TRPs #0 and #1 can transmit a total of up to 128 SSB beams in a single SSB burst set. In addition, the UE 40 can obtain a measured value of the received power or quality of each of the TRP-specific PBCH DMRSs 510 and 520 by measuring different time and frequency resources (resource elements).

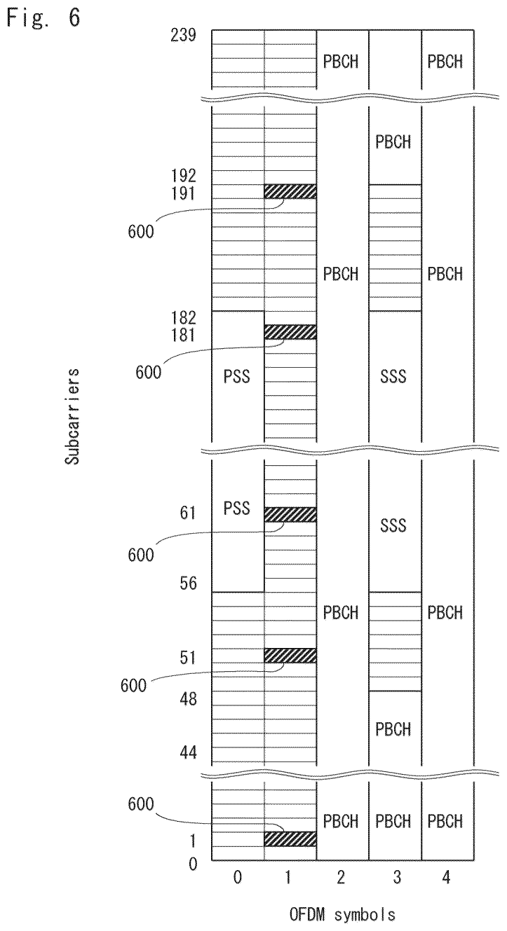

FIG. 6 shows an example of the mapping of the TRP-specific PBCH DMRS within an SSB. In the example shown in FIG. 6, an SSB is extended to span five consecutive OFDM symbols in the time domain. The frequency domain resources occupied by an SSB in FIG. 6 are the same as those of an SSB in the existing NR specifications, i.e., 240 subcarriers or 20 resource blocks. In the example in FIG. 6, the TRP-specific PBCH DMRS of one TRP is mapped to the set of resource elements 600. The multiple resource elements 600 are located in the same OFDM symbol #1 in the time domain and are separated by 10 subcarrier intervals in the frequency domain. In other words, in the example in FIG. 6, it is possible to transmit TRP-specific PBCH DMRSs of up to 10 TRPs using the 240 resource elements in OFDM symbol #1. The resource element numbers to which the TRP-specific PBCH DMRS for each TRP is mapped can be expressed by the following formula:

Resource element number=TRP ID+k×N_{TRP}

where the TRP ID is an integer greater than or equal to 0 and less than N_{TRP}, and N_{TRP} is the maximum number of TRPs in a single cell. In the example in FIG. 6, N_{TRP} is 10.

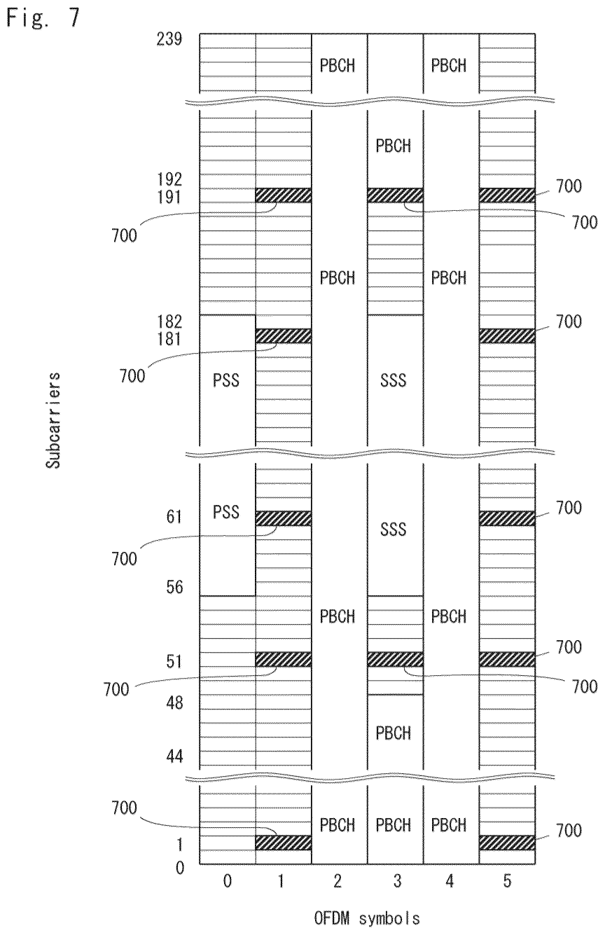

FIG. 7 shows another example of the mapping of the TRP-specific PBCH DMRS within an SSB. In the example shown in FIG. 7, one SSB is extended to span six consecutive OFDM symbols in the time domain. The frequency domain resources occupied by an SSB in FIG. 7 are the same as those of an SSB in the existing NR specification, i.e., 240 subcarriers or 20 resource blocks. In the example in FIG. 7, the TRP-specific PBCH DMRS of one TRP is mapped to the set of resource elements 700. The multiple resource elements 700 are located in OFDM symbols #1, #3, and #5 in the time domain.

By arranging the TRP-specific PBCH DMRS in time direction, it is possible to estimate a frequency offset and phase noise per TRP from the phase rotation of individual channel estimates per TRP in time direction. The UE 40 may perform either or both frequency offset compensation and phase noise compensation in advance, and then estimate the composite channel using the compensated individual channel estimates. In addition, by arranging TRP-specific PBCH DMRS in time direction, the UE 40 can receive TRP-specific PBCH DMRS with multiple receive beams within a single SSB transmission. In other words, the UE 40 can try multiple receive beams for each SSB while searching for the best receive beam.

### Second Example Embodiment

An example configuration of a radio communication system in this example embodiment may be the same as the example explained with reference to FIGS. 1 to 3. This example embodiment provides details of the operation of the base station and the UE with respect to SSB transmission and reception as described in the first example embodiment.

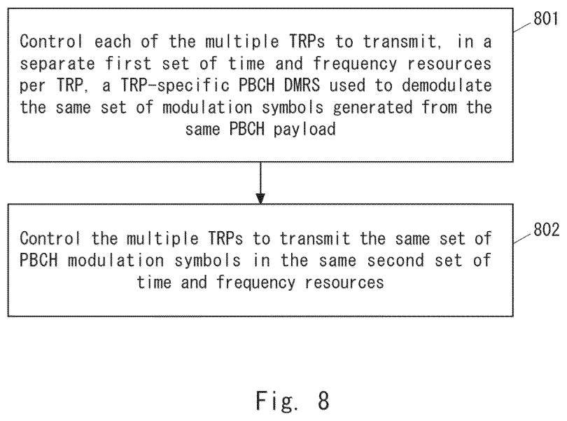

FIG. 8 shows an example of the operation of a transmission system of a base station for SSB transmission. The operation shown in FIG. 8 may be performed, for example, by the DU 21 connected to the TRPs 31 to 33 in a single cell (cell 51). The operation shown in FIG. 4 may be performed by the baseband unit 210 in the DU 21.

Steps 801 and 802 are similar to steps 401 and 402 in FIG. 4. However, in step 802, the DU 21 controls the TRPs 31 to 33 to transmit the same set of PBCH modulation symbols generated from the same PBCH payload in the same second set of time and frequency resources. In other words, the transmission system of the base station transmits the same set of PBCH modulation symbols from multiple transmission points in the same second set of time and frequency resources. The second set of time and frequency resources may be a set of resource elements.

The UE 40 receives the TRP-specific PBCH DMRS in the separate first set of time and frequency resources per TRP. In addition, the UE 40 receives the same set of PBCH modulation symbols in the second set of time and frequency resources common to the multiple TRPs. Based on the reception of the TRP-specific PBCH DMRS, the UE 40 may estimate an individual channel response between each TRP and the UE 40, and may calculate a composite channel response using multiple individual channel responses between multiple TRPs and the UE 40. The UE 40 may then demodulate and decode the same PBCH payload from the same set of PBCH modulation symbols using the composite channel response.

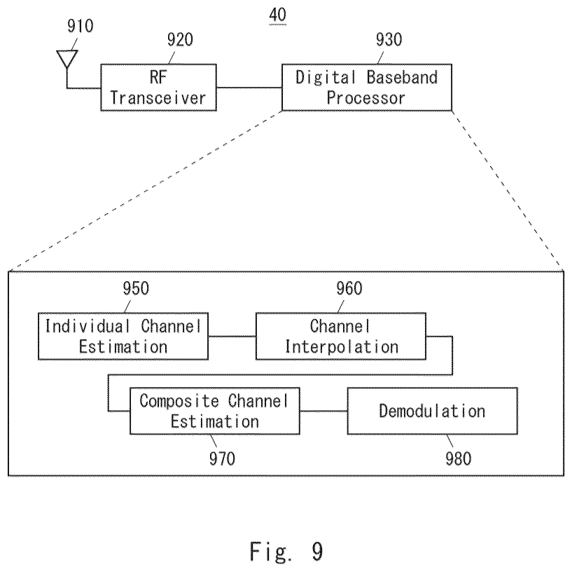

FIG. 9 shows an example configuration of the UE 40. In the example shown in FIG. 9, the UE 40 includes an antenna 910, an RF transceiver 920, and a digital baseband processor 930. The RF transceiver 920 performs analog RF signal processing to communicate with TRPs. The RF transceiver 920 may include multiple transceivers. The analog RF signal processing performed by the RF transceiver 920 includes frequency up-conversion, frequency down-conversion, and amplification. The RF transceiver 920 is coupled to the antenna 910 and the digital baseband processor 930. The RF transceiver 920 receives modulation symbol data (or OFDM symbol data) from the digital baseband processor 930, generates a transmit RF signal, and supplies the transmit RF signal to the antenna 910. The RF transceiver 920 also generates a receive baseband signal based on the receive RF signal received by the antenna 910, and supplies it to the digital baseband processor 930. The RF transceiver 920 may include an analog beamformer circuit for beamforming. The analog beamformer circuit includes, for example, multiple phase shifters and multiple power amplifiers.

The digital baseband processor 930 performs digital baseband signal processing (data plane processing) for radio communications. The digital baseband signal processing includes (a) data compression/decompression, (b) data segmentation/concatenation, (c) generation/decomposition of a transmission format (transmission frame), (d) transmission channel coding/decoding, (e) modulation (symbol mapping)/demodulation, and (f) generation of OFDM symbol data (baseband OFDM signal) using IFFT.

FIG. 9 illustrates the processing performed by the digital baseband processor 930 with respect to PBCH decoding. This includes individual channel estimation 950, individual channel interpolation 960, composite channel estimation 970, and demodulation 980. The PBCH decoding process is described below. The following symbols are used throughout this description:
k Subcarrier number or index
n TRP number
Δ TRP-specific DMRS insertion interval
P Number of subcarriers allocated for TRP-specific DMRS
Yₛ(k) PBCH payload received signal
Yₚ(k) PBCH-DMRS received signal
s(k) Common PBCH symbol
s′(k) Common PBCH symbol detected value
pₙ(k) TRP-specific DMRS
Hₙ(k) Individual channel frequency response
Hₙ′(k) Individual channel frequency response estimate
H̅(k) Composite channel frequency response
H̅′(k) Composite channel frequency response estimate
w(k) Noise

The UE 40 searches at the frequency at which SSBs or SSB beams are transmitted. To search for PSS, the UE 40 correlates the frequency-shifted received waveform with each of the possible PSS sequences and detects the strongest correlation peak. The UE 40 demodulates the synchronized waveform and extracts SSB based on the timing and frequency offset at which the strongest correlation peak is output. The UE 40 extracts resource elements related to SSS from the received resource grid and correlates them with each of the possible locally generated SSS sequences. A resource grid is the time-frequency representation of the radio resources available for transmission. A resource grid is a set of resource elements or resource blocks that are available for transmission, i.e., it consists of multiple subcarriers in the frequency domain and multiple OFDM symbols in the time domain. A resource grid may be characterized or defined by a full or whole carrier bandwidth in the frequency domain and a single subframe in the time domain. Based on the detected PSS and SSS sequences, the UE 40 identifies or calculates the physical layer cell identifier or physical cell identifier (Physical Cell Identity (PCI)). If the initial access has already been completed and the UE 40 has already identified the physical layer cell ID or PCI, the UE 40 can use the synchronization signal sequences corresponding to the identified PCI for synchronization processing, i.e., PSS and SSS search.

After completing the SSS search, the UE 40 searches for TRP-specific PBCH DMRS. The UE 40 constructs each possible TRP-specific PBCH DMRS sequence and performs individual channel estimation 950. Since DMRS from only one TRP is received at a resource location for TRP-specific PBCH DMRS, the channel response can be estimated as follows:

$${Y}_{p} ( k ) = {H}_{n} ( k ) {p}_{n} ( k ) + w ( k ) \to {{H}_{n}}^{′} ( k ) = {Y}_{p} ( k ) / {p}_{n} ( k )$$

Next, the UE 40 performs individual channel interpolation 960. The UE 40 can use any interpolation method, such as linear interpolation. Specifically, the UE 40 interpolates (or extrapolates) the individual channel estimate value of each TRP in the frequency direction (or time direction). In this way, the UE 40 obtains the channel estimation value at the resource location where the TRP-specific PBCH DMRS of the TRP is not being transmitted, as follows:

$${H}_{n}^{′} ( k ) , {H}_{n}^{′} ( k + Δ ) , {H}_{n}^{′} ( k + 2 Δ ) , … , {H}_{n}^{′} ( k + ( P - 1 ) Δ ) \to {H}_{n}^{′} ( 0 ) , {H}_{n}^{′} ( 1 ) , {H}_{n}^{′} ( 2 ) , … {H}_{n}^{′} ( K - 1 )$$

where K is the number of SSB subcarriers (e.g., 240).

The UE 40 then performs composite channel estimation 970. The UE 40 uses the individual channel estimation value for each TRP after interpolation to estimate the composite channel for multiple TRPs as follows:

$${\overline{H}}^{′} ( k ) = {\sum }_{n = 0}^{{N}_{TRP} - 1} {{H}^{′}}_{n} ( k )$$

Finally, the UE 40 performs demodulation 980. As shown below, the same PBCH modulation symbols transmitted by the multiple TRPs at the same time and frequency resources are synthesized in space and received at the UE 40:

$${Y}_{s} ( k ) = {\sum }_{n = 0}^{{N}_{TRP} - 1} {H}_{n} ( k ) s ( k ) + w ( k ) = ( {\sum }_{n = 0}^{{N}_{TRP} - 1} {H}_{n} ( k ) ) s ( k ) + w ( k ) = \overline{H} ( k ) s ( k ) + w ( k )$$

The UE 40 performs demodulation processing on the detected PBCH symbols using the obtained composite channel response estimate. The UE 40 demodulates the common PBCH payload as follows:

$${s}^{′} ( k ) = {Y}_{p} ( k ) / {\overline{H}}^{′} ( k )$$

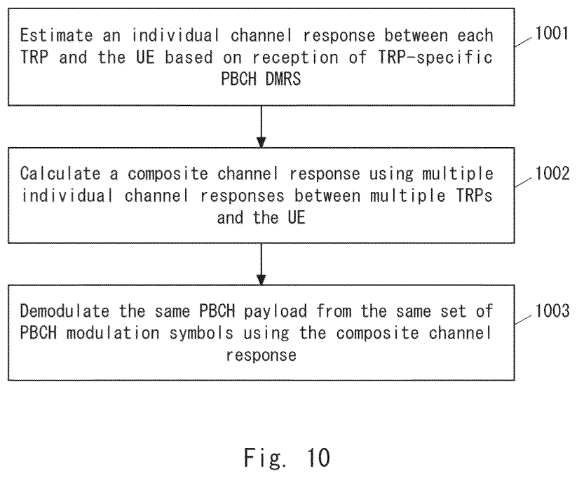

FIG. 10 shows an example of the PBCH decoding processing performed by the UE 40. In step 1001, the UE 40 estimates an individual channel response between each TRP and the UE 40 based on the reception of the TRP-specific PBCH DMRS. This corresponds to the individual channel estimation 950. In step 1002, the UE 40 computes a composite channel response using multiple individual channel responses between multiple TRPs and the UE. This corresponds to the individual channel interpolation 960 and the composite channel estimation 970 described above. In step 1003, the UE 40 demodulates the same PBCH payload from the same set of PBCH modulation symbols using the composite channel response. This corresponds to the demodulation 980 described above.

According to the operation described with reference to FIGS. 8 to 10, the base station transmission system transmits from multiple TRPs the same set of PBCH modulation symbols generated from the same PBCH payload in the same second set of time and frequency resources. In addition, the base station transmission system transmits the TRP-specific PBCH DMRS in a separate first set of time and frequency resources for each TRP. As explained in the first example embodiment, the UE 40 can receive the TRP-specific PBCH DMRS in a the separate first set of time and frequency resources per TRP. Thus, the UE 40 can measure the received power or quality of the TRP-specific PBCH DMRS in the separate first set of time and frequency resources for each TRP, and to obtain a measured value for each SSB beam. In addition, based on the reception of TRP-specific PBCH DMRS from multiple TRPs, the UE 40 can estimate an individual channel response between each of the multiple TRPs and the UE 40, and can also obtain a composite channel response necessary for demodulating the PBCH symbols common to the multiple TRPs. This allows the UE 40 to perform multipath synthesis in the space of the common PBCH symbols transmitted by the multiple TRPs. This allows multiple TRPs to transmit PBCH symbols using the same radio resource, reducing the overhead required for SSB beam sweeping.

In addition to the TRP-specific PBCH DMRS, the base station may transmit a common PBCH DMRS, i.e., a PBCH DMRS with the same sequence, from multiple TRPs in the same time and frequency resources. The sequence of the common PBCH DMRS may be generated based on the number or index of the time domain location where the common PBCH DMRS is transmitted within an SSB burst set. For example, the common PBCH DMRS sequence may be a pseudo-random sequence, and the initial value for generating the pseudo-random sequence may be generated based on the number or index of the time domain location. The UE 40 may correlate the received waveform of the common PBCH DMRS with each of the possible candidate sequences based on the number or index of the time domain location. This allows the UE 40 to identify the number or index of the time domain location within the SSB burst set to which the common PBCH DMRS was transmitted based on the strongest correlation peak.

In addition, the common PBCH DMRS transmitted by multiple TRPs using the same time and frequency resources can be used by the UE 40 to estimate the composite channel necessary to demodulate the same PBCH symbol and obtain the same PBCH payload. The UE 40 can use both the composite channel estimation value calculated based on the TRP-specific PBCH DMRS and the composite channel estimation value calculated based on the common PBCH DMRS. This improves the composite channel estimation accuracy.

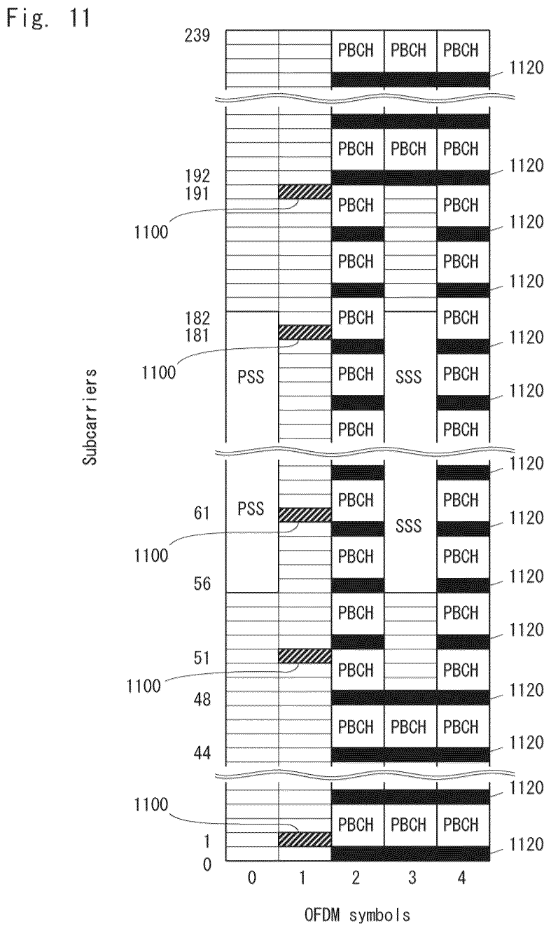

FIG. 11 shows an example of the mapping of TRP-specific PBCH DMRS and common PBCH DMRS within an SSB. In the example shown in FIG. 11, the TRP-specific PBCH DMRS of a single TRP is mapped to a set of resource elements 1100. This is the same as the mapping of TRP-specific PBCH DMRS shown in FIG. 6. In addition, in the example shown in FIG. 11, the common PBCH DMRS is mapped to a set of resource elements 1120. The multiple resource elements 1120 are located in OFDM symbols #2, #3, and #4 in the time domain.

### Third Example Embodiment

An example configuration of a radio communication system in this example embodiment may be the same as the example explained with reference to FIGS. 1 to 3. This example embodiment provides details of the identification of beams or SSBs by the UE 40 with respect to the SSB transmission and reception described in the first and second example embodiments.

In a first implementation, the location of the separate first set of time and frequency resources per TRP in which the TRP-specific PBCH DMRS is transmitted is associated with the identification information of the TRP (or transmission point). In a second implementation, the location of the separate first set of time and frequency resources per TRP in which the TRP-specific PBCH DMRS is transmitted is associated with at least a portion of an identifier or index for distinguishing between multiple beams or multiple SSBs transmitted by multiple TRPs. In these implementations, the UE 40 identifies or determines an identifier or index for distinguishing between multiple beams or multiple SSBs transmitted by multiple TRPs, based at least on the location of the separate first set of time and frequency resources. The location of the separate first set of time and frequency resources per TRP in which TRP-specific PBCH DMRS is transmitted refers to the location of this set of time and frequency resources within the resource grid. The location of the first set of time and frequency resources may be referred to as the arrangement, mapping pattern, transmission pattern, or allocation pattern of the first set of time and frequency resources within the resource grid. A resource grid is the time-frequency representation of the radio resources available for transmission. A resource grid is a set of resource elements or resource blocks that are available for transmission, i.e., it consists of multiple subcarriers in the frequency domain and multiple OFDM symbols in the time domain. A resource grid may be characterized or defined by a full or whole carrier bandwidth in the frequency domain and a single subframe in the time domain.

In the case of the first and second implementations, the identifier or index for distinguishing between multiple beams or multiple SSBs may be divided into multiple fields. These multiple fields include at least a first field associated with the location in the resource grid of the separate first set of time and frequency resources. These multiple fields may further include at least one of the following fields:
A second field carried in the PBCH payload;
A third field carried in the TRP-specific PBCH DMRS sequence;
A fourth field carried in the PBCH DMRS sequence common to multiple TRPs; and
A fifth field carried in the PSS or SSS sequence.

In a third implementation, the TRP-specific PBCH DMRS is generated based on the identification information of each TRP, and thus has a different sequence for each TRP. In a fourth implementation, the TRP-specific PBCH DMRS is generated based on an identifier or index for distinguishing between multiple beams or multiple SSBs transmitted by multiple TRPs, and thus has a different sequence for each TRP. In these implementations, the UE 40 identifies or determines an identifier or index for distinguishing between multiple beams or multiple SSBs, based at least on the sequence of TRP-specific PBCH DMRS received in the separate first set of time and frequency resources.

In the case of the third and fourth implementations, the identifier or index for distinguishing between multiple beams or multiple SSBs may be divided into multiple fields. These multiple fields include at least a first field that is transmitted in the TRP-specific PBCH DMRS sequence. These multiple fields may further include at least one of the following fields:
A second field carried in the PBCH payload;
A third field carried in the PBCH DMRS sequence common to multiple TRPs; and
A fourth field carried in the PSS or SSS sequence.

In the first to fourth implementations, the UE 40 may measure the received power or received quality in the separate first set of time and frequency resources carrying the TRP-specific PBCH DMRS. The UE 40 may then determine the best beam or best SSB based on the measured values of the received power or received quality and the identified beam or SSB identifier (or index). Additionally or alternatively, the UE 40 may report the measured received power or received quality to the radio access network (e.g., base station) along with the associated identified beam or SSB identifier (or index).

### Fourth Example Embodiment

An example configuration of a radio communication system in this example embodiment may be the same as the example explained with reference to FIGS. 1 to 3. This example embodiment provides details of the arrangement of the TRP-specific PBCH DMRS within an SSB with respect to the SSB transmission and reception described in the first and second example embodiments.

The transmission system of the base station may shift the time and frequency resources (e.g., resource elements) where the TRP-specific PBCH DMRS is mapped within an SSB, depending on or according to the physical layer cell identifier (PCI). In other words, the transmission system of the base station may change the arrangement or mapping of the TRP-specific PBCH DMRS within an SSB based on the physical layer cell identifier. The UE 40 may assume that the TRP-specific PBCH DMRS arrangement or mapping within an SSB will be changed in this way. This helps to reduce inter-cell interference of the TRP-specific PBCH DMRS. For example, the resource element number to which the TRP-specific PBCH DMRS is mapped for each TRP can be expressed by the following formula:

$$Resource element number = c + k \times {N}_{TRP}$$

where c is expressed by the following formula:

$$c = ( TRP ID + {N}_{ID}^{cell} ) mod {N}_{TRP}$$

where TRP ID is an integer greater than or equal to 0 and less than NTRP, N_{TRP} is the maximum number of TRPs in a cell, N_{ID}^{cell} is the physical layer cell identifier, and k is an integer greater than or equal to 0. N_{ID}^{cell} is indicated by the PSS and SSS sequences.

Additionally or alternatively, the transmission system of the base station may change the time and frequency resources (e.g., resource elements) within an SSB over which the TRP-specific PBCH DMRS is mapped, depending on or based on the number of TRPs (or transmission points) that may be used or are being used in the cell. In other words, the transmission system of the base station may change the arrangement or mapping of the TRP-specific PBCH DMRS within an SSB, based on the number of TRPs that can be used or are being used in the cell. Further, in other words, the transmission system of the base station may change the arrangement or mapping of the TRP-specific PBCH DMRS within an SSB depending on or according to the number of TRPs that may transmit or are transmitting simultaneously at a single candidate time domain location within an SSB burst set. Alternatively, the transmission system of the base station may change the arrangement or mapping of the TRP-specific PBCH DMRS within an SSB depending on or according to the number of SSBs or beams that may be transmitted or are being transmitted simultaneously at a single candidate time domain location within an SSB burst set. The UE 40 may assume that the TRP-specific PBCH DMRS arrangement or mapping within an SSB will be changed in this way.

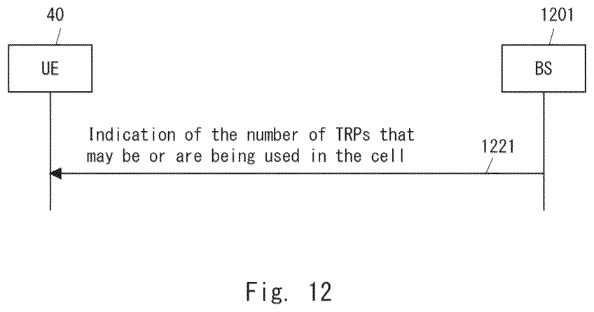

In this case, as shown in FIG. 12, a base station (BS) 1201 notifies the UE 40 of the number of TRPs that may be used or are being used in the cell (step 1221). Alternatively, the base station 1201 notifies the UE 40 of the number of TRPs that may transmit or are transmitting simultaneously at a candidate time domain location in an SSB burst set. Alternatively, the base station 1201 notifies the UE 40 of the number of SSBs or beams that may be transmitted or are being transmitted simultaneously at a candidate time domain location within an SSB burst set. The base station 1201 is, for example, the CU 10 or the DU 21. This allows the UE 40 to determine the arrangement or mapping of the TRP-specific PBCH DMRS.

More specifically, the base station 1201 transmits an indication of the number of TRPs that may be used or are being used within a cell (e.g., cell 51) in that cell using a signal, physical channel, or message that is received by at least a plurality of radio terminals in an idle state. In other words, the base station 1201 broadcasts an indication of the number of TRPs that can be used or are being used within a cell (e.g., cell 51) in that cell. The indication may indicate the number of TRPs that can transmit or are transmitting SSBs simultaneously at a candidate time domain location within an SSB burst set in a cell. In other words, the indication may indicate the number of TRPs that can transmit or are transmitting the same set of PBCH symbols or a different set of PBCH symbols at the same second set of time and frequency resources. Further, in other words, the above-mentioned indication may indicate the number of SSBs or SSB beams that can be transmitted or are being transmitted simultaneously at a candidate time domain position within an SSB burst set in a cell. The indication of the number of TRPs may be referred to as information, data, a configuration, or configuration information indicating the number of TRPs.

The base station may transmit the indication using a signal or physical channel contained within the SSB. Alternatively, the base station may transmit the indication using System Information Block Type 1 (SIB1). The base station may transmit the indication using another SIB. The indication may be divided into multiple fields and transmitted over multiple signals or physical channels.

In one implementation, the base station may provide the indication to the UEs 40 using at least the sequence of a synchronization signal transmitted in the SSB, i.e., the PSS or the SSS. Additionally or alternatively, the base station may provide the indication to the UEs 40 using at least the sequence of a common PBCH DMRS transmitted by multiple TRPs in the SSB at the same time and frequency resources.

In other implementations, the base station may provide the indication to the UEs 40 using at least the PBCH payload (e.g., MIB) transmitted by multiple TRPs in the same time and frequency resources in the SSB. Additionally or alternatively, the base station may provide the indication to the UEs 40 using at least configuration information in SIB1. In these cases, the UE 40 cannot know the number of simultaneously transmitting TRPs or the number of simultaneously transmitted SSB beams until it has decoded the PBCH payload (e.g., MIB) and/or SIB1. Consequently, the UE 40 cannot identify the arrangement of the TRP-specific PBCH DMRS in the SSB until it has decoded either or both the PBCH payload (e.g., MIB) and SIB1. Accordingly, the base station needs to transmit the PBCH DMRS common to multiple TRPs in the SSB to enable the UEs 40 to estimate the composite channel and decode the PBCH payload.

Based on the indication, the UE 40 may determine the number of TRPs that may transmit or are transmitting SSBs simultaneously at a candidate time domain location within the SSB burst set in the cell. In other words, the UE 40 may identify, based on the indication, the number of SSBs or SSB beams that may be transmitted or are being transmitted simultaneously at a candidate time domain location within the SSB burst set in the cell. Further, in other words, the UE 40 may identify, based on the indication, the arrangement or mapping of the TRP-specific PBCH DMRS within the SSB.

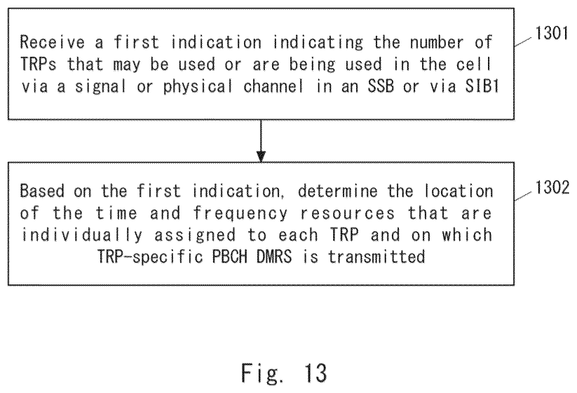

FIG. 13 shows an example of the operation of the UE 40. In step 1301, the UE 40 receives a first indication indicating the number of TRPs that may be used or are being used in the cell, either via a signal or physical channel in the SSB or via SIB1. In step 1302, based on the received first indication, the UE 40 determines the location of the time and frequency resources that are individually assigned to each TRP and on which the TRP-specific PBCH DMRS is transmitted.

### Fifth Example Embodiment

An example configuration of a radio communication system in this example embodiment may be the same as the example explained with reference to FIGS. 1 to 3. This example embodiment provides details of SSB transmission in a configuration where each TRP has multiple sub-arrays.

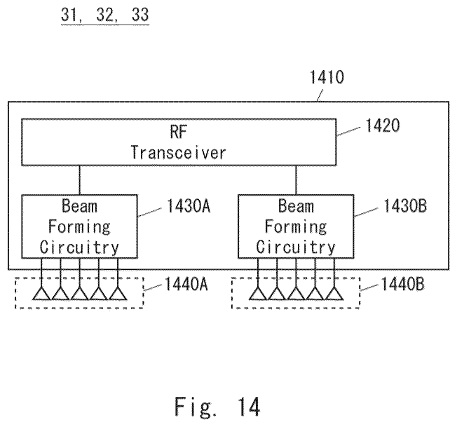

FIG. 14 shows an example configuration of the TRPs 31, 32, and 33. In the example shown in FIG. 14, each of the TRPs 31 to 33 includes an RF component 1410. The RF component 1410 is coupled to two antenna subarrays 1440A and 1440B. The RF component 1410 includes an RF transceiver 1420 and beamforming circuitry 1430A and 1430B. The beamforming circuitry 1430A determines the beam direction by adjusting one or both of the phase and amplitude of the radio signals supplied to the multiple antenna elements of the antenna subarray 1440A. Similarly, the beamforming circuitry 1430B determines the beam direction by adjusting one or both of the phase and amplitude of the radio signals supplied to the multiple antenna elements of the antenna subarray 1440B.

Each TRP transmits multiple SSB beams from multiple antenna subarrays using different frequency resources (e.g., subcarriers) at the same candidate time domain location within an SSB burst set. For example, each TRP transmits the same set or one of different sets of PBCH modulation symbols from the first antenna subarray 1440A in a second set of time and frequency resources common to the multiple TRPs, and does not transmit from the second antenna subarray 1440B in that second set of time and frequency resources. This can reduce the time required to transmit all SSBs or SSB beams. In other words, this can help to complete the transmission of all SSBs or SSB beams in a smaller number of candidate time domain locations.

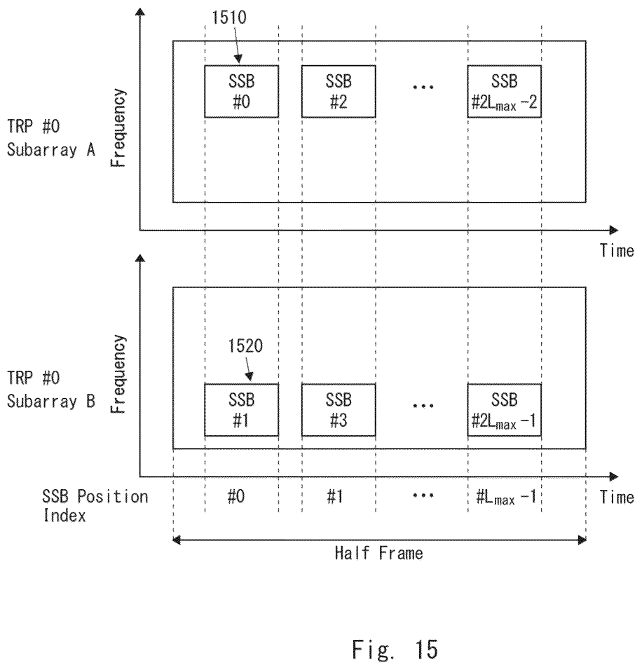

FIG. 15 shows an example of SSB transmission within a single SSB burst set from multiple antenna subarrays of a single TRP. In the example shown in FIG. 15, the maximum number of candidate time domain locations where SSBs can be transmitted within a single SSB burst set is Lₘₐₓ. The number of SSBs actually transmitted by each TRP is configurable and may be less than the maximum. TRP #0 is equipped with antenna subarrays A and B. Antenna subarrays A and B transmit two SSBs simultaneously on different frequency resources (or subcarriers), while sharing the same candidate time domain location within the SSB burst set. For example, looking at candidate time domain location #0, antenna subarrays A and B transmit SSB 1510 (SSB #0) and SSB 1520 (SSB #1) on different frequency resources.

As described in the fourth example embodiment, the base station may change the arrangement or mapping of the TRP-specific PBCH DMRS within an SSB depending on or according to the number of SSBs or beams that may be transmitted or are being transmitted simultaneously at a candidate time domain location within the SSB burst set. In this case, the base station may inform the UE 40 of the maximum number of subarrays of each TRP together with the number of TRPs that may be used or are being used in the cell.

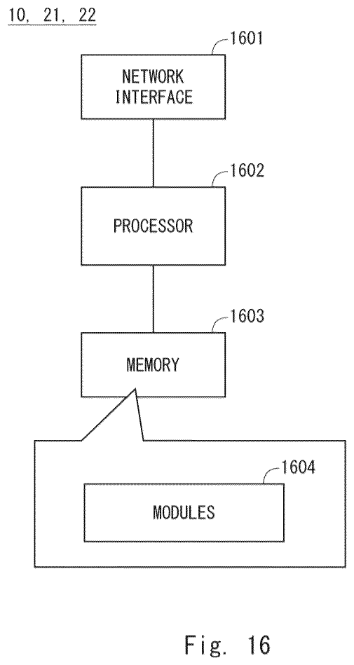

The following describes example configurations of the CU 10, the DUs 21 and 22, the TRPs 31 to 35, and the UE 40 shown in FIG. 1. FIG. 16 shows a block diagram of an example configuration of the CU 10. The configuration of the DUs 21 and 22 may be similar to that shown in FIG. 16. Referring to FIG. 16, the CU 10 includes a network interface 1601, a processor 1602, and a memory 1603. The network interface 1601 is used to communicate with network nodes (e.g., DUs, and control plane (CP) nodes and/or user plane (UP) nodes in the core network). The network interface 1601 may include a plurality of interfaces. The network interface 1601 may include, for example, a fiber optic interface for communication between the CU and DUs and a network interface compliant with the IEEE 802.3 series.

The processor 1602 may include a plurality of processors. If the CU 10 is a CU-CP, the processor 1602 performs control plane processing, such as processing related to NGAP, RRC, E1AP, and F1AP signaling. If the CU 10 includes a CU-UP, the processor 1602 performs, for example, NG-U interface termination, F1-U interface termination, and data processing for the SDAP and PDCP layers.

In the case of the DUs 21 and 22, the processor 1602 performs digital baseband signal processing (data plane processing) and control plane processing for wireless communications. For example, the processor 1602 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing. The digital baseband signal processing may include signal processing for the RLC, MAC, and PHY layers. The control plane processing may include processing of MAC CEs and DCIs. The processor 1602 may include a digital beamformer module for beamforming. The digital beamformer module may include a Multi-Input Multi-Output (MIMO) encoder and precoder.

The memory 1603 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 1603 may include storage that is remote from the processor 1602. In this case, the processor 1602 may access the memory 1603 through the network interface 1601 or another I/O interface.

The memory 1603 may store one or more software modules (or computer programs) 1604 containing a set of instructions and data for processing by the CU 10 described in the plurality of embodiments described above. In some implementations, the processor 1602 may be configured to read and execute the one or more software modules 1604 from the memory 1603, thereby performing the processing of the CU 10 described in the example embodiments described above.

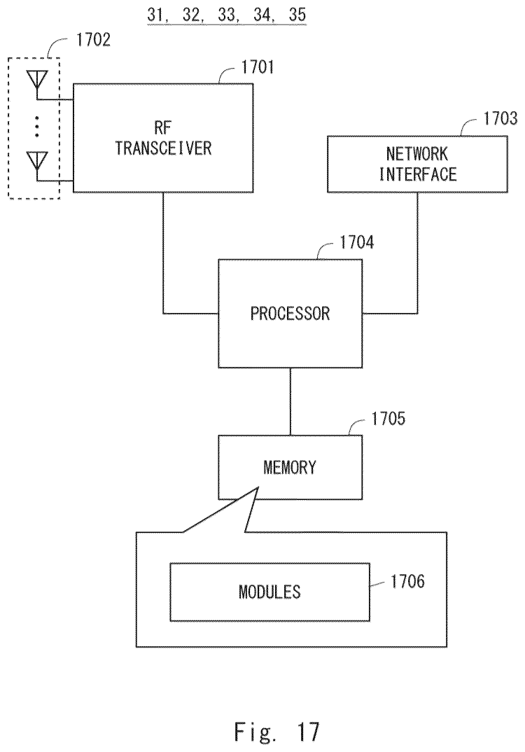

FIG. 17 is a block diagram showing an example configuration of the TRPs 31 to 35. Referring to FIG. 17, each of the TRPs 31 to 35 includes an RF transceiver 1701, a network interface 1703, a processor 1704, and a memory 1705. The RF transceiver 1701 performs analog RF signal processing to communicate with the UEs. The RF transceiver 1701 may include a plurality of transceivers. The RF transceiver 1701 is coupled to an antenna array 1702 and the processor 1704. The RF transceiver 1701 receives modulated symbol data from the processor 1704, generates a transmission RF signal, and supplies the transmission RF signal to the antenna array 1702. The RF transceiver 1701 generates a baseband reception signal based on a reception RF signal received by the antenna array 1702 and supplies the baseband reception signal to the processor 1704. The RF transceiver 1701 may include an analog beamformer circuit for beamforming. The analog beamformer circuit includes, for example, a plurality of phase shifters and a plurality of power amplifiers.

The network interface 1703 is used to communicate with network nodes (e.g., DUs, other TRPs). The network interface 1703 may include a plurality of interfaces. The network interface 1703 may include, for example, a fiber optic interface for communication between a DU and a TRP (and between TRPs) and a network interface compliant with the IEEE 802.3 series.

The processor 1704 may include one or more processors. The processor 1704 may include a DFE and a controller. The DFE provides low PHY layer signal processing and digital radio signal processing.

The memory 1705 is composed of a combination of volatile and non-volatile memory. The volatile memory is, for example, SRAM, DRAM, or a combination thereof. The non-volatile memory is MROM, EEPROM, flash memory, hard disk drive, or any combination thereof. The memory 1705 may include storage that is remote from the processor 1704. In this case, the processor 1704 may access the memory 1705 through the network interface 1703 or an I/O interface not shown.

The memory 1705 may store one or more software modules (or computer programs) 1706 containing a set of instructions and data for performing at least a portion of the processing by the TRPs 31 to 35 described in the example embodiments described above. In some implementations, the processor 1704 may be configured to read and execute the software module 1706 from the memory 1705, thereby performing at least a portion of the processing of the TRPs 31 to 35 described in the example embodiments described above.

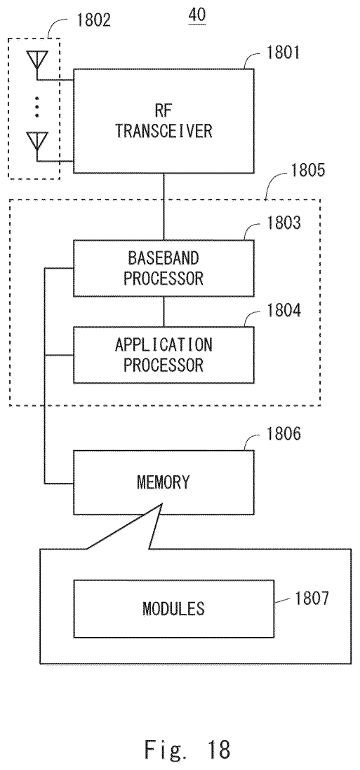

FIG. 18 is a block diagram showing an example configuration of the UE 40. The RF transceiver 1801 performs analog RF signal processing to communicate with the TRPs. The RF transceiver 1801 may include a plurality of transceivers. The analog RF signal processing performed by the RF transceiver 1801 includes frequency up-conversion, frequency down-conversion, and amplification. The RF transceiver 1801 is coupled with an antenna array 1802 and a baseband processor 1803. The RF transceiver 1801 receives modulated symbol data (or OFDM symbol data) from the baseband processor 1803, generates a transmission RF signal, and supplies the transmission RF signal to the antenna array 1802. The RF transceiver 1801 also generates a baseband received signal based on a received RF signal received by the antenna array 1802, and supplies the baseband received signal to the baseband processor 1803. The RF transceiver 1801 may include an analog beamformer circuit for beamforming. The analog beamformer circuit includes, for example, multiple phase shifters and multiple power amplifiers.

The baseband processor 1803 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e.g., transmission power control), layer 2 (e.g., radio resource management, and hybrid automatic repeat request (HARQ) processing), and layer 3 (e.g., signaling related to attach, mobility, and call management).

For example, the digital baseband signal processing performed by the baseband processor 1803 may include signal processing for the SDAP, PDCP, RLC, MAC, and PHY layers. The control plane processing by the baseband processor 1803 may include processing of Non-Access Stratum (NAS) protocols, RRC protocols, MAC CEs, and DCIs.

The baseband processor 1803 may perform MIMO encoding and precoding for beamforming.

The baseband processor 1803 may include a modem processor (e.g., DSP) that performs digital baseband signal processing and a protocol stack processor (e.g., CPU or MPU) that performs control plane processing. In this case, the protocol stack processor that performs control plane processing may be integrated with an application processor 1804 described later.

The application processor 1804 is also referred to as a CPU, MPU, microprocessor, or processor core. The application processor 1804 may include a plurality of processors (a plurality of processor cores). The application processor 1804 executes system software programs (operating system (OS)) and various application programs (e.g., voice call application, web browser, mailer, camera control application, music player application) read from a memory 1806 or other memory not shown, thereby realizing various functions of the UE 40.

In some implementations, as shown by the dashed line (1805) in FIG. 18, the baseband processor 1803 and the application processor 1804 may be integrated on a single chip. In other words, the baseband processor 1803 and the application processor 1804 may be implemented as a single System on Chip (SoC) device 1805. The SoC device may also be referred to as a system large-scale integration (LSI) or chipset.

The memory 1806 is a volatile memory, a non-volatile memory, or a combination thereof. The memory 1806 may include a plurality of physically independent memory devices. The volatile memory is, for example, SRAM, DRAM, or a combination thereof. The non-volatile memory is, for example, MROM, EEPROM, flash memory, or a hard disk drive, or any combination thereof. For example, the memory 1806 may include an external memory device that is accessible by the baseband processor 1803, the application processor 1804, and the SoC 1805. The memory 1806 may include an internal memory device that is integrated into the baseband processor 1803, the application processor 1804, or the SoC 1805. In addition, the memory 1806 may include memory within a Universal Integrated Circuit Card (UICC).

The memory 1806 may store one or more software modules (or computer programs) 1807 that include a set of instructions and data for performing the processing by the radio terminal 3 described in the above example embodiments. In some implementations, the baseband processor 1803 or the application processor 1804 may be configured to read and execute the software modules 1807 from the memory 1806, thereby performing the processing of the UE 40 as described in the example embodiments with reference to the drawings.

The control plane processing and operations performed by the UE 40 described in the above example embodiment can be implemented by elements other than the RF transceiver 1801 and the antenna array 1802, namely at least one of the baseband processor 1803 and the application processor 1804, and the memory 1806 that stores the software modules 1807.

As described using FIGS. 16, 17, and 18, each of the processors in the CU, DUs, TRPs, and UEs of the above example embodiment can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### Supplementary Note 1

A transmission system of a base station, comprising:
a plurality of transmission points; and
a baseband unit configured to:
   control each of the plurality of transmission points to transmit a first demodulation reference signal used to demodulate a same set or one of different sets of modulation symbols generated from a same broadcast channel payload or from different broadcast channel payloads, in a separate first set of time and frequency resources per transmission point; and
   control the plurality of transmission points to transmit the same set of modulation symbols or the different sets of modulation symbols in a same second set of time and frequency resources.

### Supplementary Note 2

The transmission system according to Supplementary Note 1, wherein the baseband unit is configured to control the plurality of transmission points to transmit the same set of modulation symbols generated from the same broadcast channel payload in the same second set of time and frequency resources.

### Supplementary Note 3

The transmission system according to Supplementary Note 1 or 2, wherein a location of the dedicated first set of time and frequency resources in a resource grid is associated with identification information of a transmission point.

### Supplementary Note 4

The transmission system according to Supplementary Note 1 or 2, wherein a location of the dedicated first set of time and frequency resources in a resource grid is associated with at least a portion of an identifier or index for distinguishing between a plurality of beams or a plurality of synchronization signal and physical broadcast channel blocks transmitted from the plurality of transmission points.

### Supplementary Note 5

The transmission system according to Supplementary Note 4, wherein
the identifier or the index is divided into a plurality of fields, and
the plurality of fields includes at least a first field associated with the location of the dedicated first set of time and frequency resources in the resource grid.

### Supplementary Note 6

The transmission system according to Supplementary Note 5, wherein the plurality of fields further includes at least one of:
a second field carried in the broadcast channel payload;
a third field carried in a sequence of the first demodulation reference signal;
a fourth field carried in a sequence of a second demodulation reference signal transmitted by the plurality of transmission points in a same third set of time and frequency resources; and
a fifth field carried in a sequence of a synchronization signal transmitted by the plurality of transmission points in a same fourth set of time and frequency resources.

### Supplementary Note 7

The transmission system according to any one of Supplementary Notes 1 to 4, wherein the first demodulation reference signal has a different sequence per transmission point by being generated based on identification information of a transmission point.

### Supplementary Note 8

The transmission system according to any one of Supplementary Notes 1 to 4, wherein the first demodulation reference signal has a different sequence per transmission point by being generated based on an identifier or index for distinguishing between a plurality of beams or a plurality of synchronization signal and physical broadcast channel blocks transmitted from the plurality of transmission points.

### Supplementary Note 9

The transmission system according to Supplementary Note 8, wherein
the identifier or the index is divided into a plurality of fields, and
the plurality of fields includes at least a first field to be transmitted in a sequence of the first demodulation reference signal.

### Supplementary Note 10

The transmission system according to Supplementary Note 9, wherein the plurality of fields further includes at least one of:
a second field carried in the broadcast channel payload;
a third field carried in a sequence of a second demodulation reference signal transmitted by the plurality of transmission points in a same third set of time and frequency resources; and
a fourth field carried in a sequence of a synchronization signal transmitted by the plurality of transmission points in a same fourth set of time and frequency resources.

### Supplementary Note 11

The transmission system according to any one of Supplementary Notes 1 to 10, wherein the baseband unit is configured to indicate, at least using a sequence of a synchronization signal transmitted by the plurality of transmission points in a same set of time and frequency resources, a total number of transmission points in a cell transmitting in the same second set of time and frequency resources or a total number of beams transmitted in a cell in the same second set of time and frequency resources.

### Supplementary Note 12

The transmission system according to any one of Supplementary Notes 1 to 10, wherein the baseband unit is configured to indicate, at least using a sequence of a second demodulation reference signal transmitted by the plurality of transmission points in a same set of time and frequency resources, a total number of transmission points in a cell transmitting in the same second set of time and frequency resources or a total number of beams transmitted in a cell in the same second set of time and frequency resources.

### Supplementary Note 13

The transmission system according to any one of Supplementary Notes 1 to 10, wherein the baseband unit is configured to indicate, at least using the broadcast channel payload, a total number of transmission points in a cell transmitting in the same second set of time and frequency resources or a total number of beams transmitted in a cell in the same second set of time and frequency resources.

### Supplementary Note 14

The transmission system according to any one of Supplementary Notes 1 to 10, wherein the baseband unit is configured to indicate, at least using configuration information within a System Information Block Type 1 (SIB1), a total number of transmission points in a cell transmitting in the same second set of time and frequency resources or a total number of beams transmitted in a cell in the same second set of time and frequency resources.

### Supplementary Note 15

The transmission system according to any one of Supplementary Notes 1 to 14, wherein
each transmission point is coupled to a first antenna sub-array and a second antenna sub-array, and
each transmission point is configured to:
   transmit the same set of modulation symbols or one of the different sets of modulation symbols in the same second set of time and frequency resources from the first antenna sub-array; and
   not transmit from the second antenna sub-array in the same second set of time and frequency resources.

### Supplementary Note 16

The transmission system according to any one of Supplementary Notes 1 to 15, wherein both the first set of time and frequency resources carrying the first demodulation reference signal of each transmission point and the same second set of time and frequency resources carrying the same set of modulation symbols or the different sets of modulation symbols are contained within a synchronization signal and physical broadcast channel block, together with a set of time and frequency resources carrying one or more synchronization signals.

### Supplementary Note 17

The transmission system according to any one of Supplementary Notes 1 to 16, wherein the plurality of transmission points described above are located within a single cell and are associated with a same cell identifier.

### Supplementary Note 18

A method performed by a transmission system of a base station, the method comprising:
transmitting a first demodulation reference signal used to demodulate a same set or one of different sets of modulation symbols generated from a same broadcast channel payload or from different broadcast channel payloads, from each of a plurality of transmission points, in a separate first set of time and frequency resources per transmission point; and
transmitting the same set of modulation symbols or the different sets of modulation symbols from the plurality of transmission points in a same second set of time and frequency resources.

### Supplementary Note 19

A program containing a plurality of instructions that, when executed by at least one processor of a transmission system of a base station, cause the transmission system to perform a method, wherein the method comprises:
controlling a plurality of transmission points to transmit a first demodulation reference signal used to demodulate a same set or one of different sets of modulation symbols generated from a same broadcast channel payload or from different broadcast channel payloads, in a separate first set of time and frequency resources per transmission point; and
controlling the plurality of transmission points to transmit the same set of modulation symbols or the different sets of modulation symbols in a same second set of time and frequency resources.

### Supplementary Note 20

A radio terminal comprising:
a radio frequency (RF) circuit configured to communicate with a radio access network; and
at least one processor coupled to the RF circuit and configured to:
   control the RF circuit to receive, in a separate first set of time and frequency resources per transmission point, a first demodulation reference signal used to demodulate a same set or one of different sets of modulation symbols generated from a same broadcast channel payload or from different broadcast channel payloads; and
   control the RF circuit to receive, in a second set of time and frequency resources common to a plurality of transmission points, the same set of modulation symbols or one of the different sets of modulation symbols.

### Supplementary Note 21

The radio terminal according to Supplementary Note 20, wherein
the first demodulation reference signal is used to demodulate the same set of modulation symbols generated from the same broadcast channel payload, and
the at least one processor is configured to control the RF circuit to receive the same set of modulation symbols in the common second set of time and frequency resources.

### Supplementary Note 22

The radio terminal according to Supplementary Note 21, wherein the at least one processor is configured to:
estimate an individual channel response between each transmission point and the radio terminal based on the reception of the demodulation reference signal;
calculate a composite channel response using the plurality of individual channel responses between the plurality of transmission points and the radio terminal; and
demodulate the same broadcast channel payload from the same set of modulation symbols using the composite channel response.

### Supplementary Note 23

The radio terminal according to any one of Supplementary Notes 20 to 22, wherein the at least one processor is configured to identify an identifier or index for distinguishing between a plurality of beams or a plurality of synchronization signal and physical broadcast channel blocks transmitted from the plurality of transmission points, based at least on a location of the dedicated first set of time and frequency resources in a resource grid.

### Supplementary Note 24

The radio terminal according to any one of Supplementary Notes 20 to 22, wherein the at least one processor is configured to identify an identifier or index for distinguishing between a plurality of beams or a plurality of synchronization signal and physical broadcast channel blocks transmitted from the plurality of transmission points, based at least on a sequence of the first demodulated reference signal received in the dedicated first set of time and frequency resources.

### Supplementary Note 25

The radio terminal according to Supplementary Note 23 or 24, wherein the at least one processor is configured to:
measure received power or quality in the dedicated first set of time and frequency resources carrying the first demodulation reference signal; and
determine a best beam or a best synchronous signal and physical broadcast channel block based on the received power or received quality and the identifier or index.

### Supplementary Note 26

The radio terminal according to Supplementary Note 23 or 24, wherein the at least one processor is configured to:
measure received power or received quality in the dedicated first set of time and frequency resources carrying the first demodulation reference signal; and
report the received power or received quality to the radio access network along with the associated identifier or index.

### Supplementary Note 27

The radio terminal according to any one of Supplementary Notes 20 to 26, wherein the at least one processor is configured to identify a total number of transmission points in a cell transmitting in the same second set of time and frequency resources or a total number of beams transmitted in a cell in the same second set of time and frequency resources, based at least on a sequence of a synchronization signal transmitted by the plurality of transmission points in a same set of time and frequency resources.

### Supplementary Note 28

The radio terminal according to any one of Supplementary Notes 20 to 26, wherein the at least one processor is configured to identify a total number of transmission points in a cell transmitting in the same second set of time and frequency resources or a total number of beams transmitted in a cell in the same second set of time and frequency resources, based at least on a sequence of a second demodulation reference signal transmitted by the plurality of transmission points in a same set of time and frequency resources.

### Supplementary Note 29

The radio terminal according to any one of Supplementary Notes 20 to 26, wherein the at least one processor is configured to identify a total number of transmission points in a cell transmitting in the same second set of time and frequency resources or a total number of beams transmitted in a cell in the same second set of time and frequency resources, based at least on the broadcast channel payload.

### Supplementary Note 30

The radio terminal according to any one of Supplementary Notes 20 to 26, wherein the at least one processor is configured to identify a total number of transmission points in a cell transmitting in the same second set of time and frequency resources or a total number of beams transmitted in a cell in the same second set of time and frequency resources, based at least on configuration information within a System Information Block Type 1 (SIB1).

### Supplementary Note 31

The radio terminal according to any one of Supplementary Notes 27 to 30, wherein the at least one processor is configured to identify a location of the dedicated first set of time and frequency resources in a resource grid, based on the total number of transmission points in the cell transmitting in the same second set of time and frequency resources or the total number of beams transmitted in the cell in the same second set of time and frequency resources.

### Supplementary Note 32

A method performed by a radio terminal, the method comprising:
receiving, in a separate first set of time and frequency resources per transmission point, a first demodulation reference signal used to demodulate a same set or one of different sets of modulation symbols generated from a same broadcast channel payload or from different broadcast channel payloads; and
receiving, in a second set of time and frequency resources common to a plurality of transmission points, the same set of modulation symbols or one of the different sets of modulation symbols.

### Supplementary Note 33

A program containing a plurality of instructions that, when executed by at least one processor of a radio terminal, cause the radio terminal to perform a method, wherein the method comprises:
controlling a radio frequency (RF) circuit of the radio terminal to receive, in a separate first set of time and frequency resources per transmission point, a first demodulation reference signal used to demodulate a same set or one of different sets of modulation symbols generated from a same broadcast channel payload or from different broadcast channel payloads; and
controlling the RF circuit to receive, in a second set of time and frequency resources common to a plurality of transmission points, the same set of modulation symbols or one of the different sets of modulation symbols.

### Supplementary Note 34

A radio terminal comprising:
a radio frequency (RF) circuit configured to communicate with a radio access network; and
at least one processor coupled to the RF circuit and configured to:
   control the RF circuit to receive a demodulation reference signal used to demodulate a broadcast channel, wherein the demodulation reference signal is transmitted in a first set of time and frequency resources that are dedicatedly assigned per transmission point, and the broadcast channel is transmitted by a plurality of transmission points in a same second set of time and frequency resources; and
   determine, based at least on a location within a resource grid of a time and frequency resource at which the demodulated reference signal is received, a portion of an identifier or index for distinguishing between a plurality of beams or a plurality of synchronization signal and physical broadcast channel blocks transmitted from the plurality of transmission points.

### Supplementary Note 35

A method performed by a radio terminal, the method comprising:
receiving a demodulation reference signal used to demodulate a broadcast channel, wherein the demodulation reference signal is transmitted in a first set of time and frequency resources that are dedicatedly assigned per transmission point, and the broadcast channel is transmitted by a plurality of transmission points in a same second set of time and frequency resources; and
determining, based at least on a location within a resource grid of a time and frequency resource at which the demodulated reference signal is received, a portion of an identifier or index for distinguishing between a plurality of beams or a plurality of synchronization signal and physical broadcast channel blocks transmitted from the plurality of transmission points.

### Supplementary Note 36

A program containing a plurality of instructions that, when executed by at least one processor of a radio terminal, cause the radio terminal to perform a method, wherein the method comprises:
controlling a radio frequency (RF) circuit of the radio terminal to receive a demodulation reference signal used to demodulate a broadcast channel, wherein the demodulation reference signal is transmitted in a first set of time and frequency resources that are dedicatedly assigned per transmission point, and the broadcast channel is transmitted by a plurality of transmission points in a same second set of time and frequency resources; and
determining, based at least on a location within a resource grid of a time and frequency resource at which the demodulated reference signal is received, a portion of an identifier or index for distinguishing between a plurality of beams or a plurality of synchronization signal and physical broadcast channel blocks transmitted from the plurality of transmission points.

### Supplementary Note 37

A Distributed Unit (DU) of a base station, the DU comprising:
means for controlling a plurality of transmission points to transmit a first demodulation reference signal used to demodulate a same set or one of different sets of modulation symbols generated from a same broadcast channel payload or from different broadcast channel payloads, in a separate first set of time and frequency resources per transmission point; and
means for controlling the plurality of transmission points to transmit the same set of modulation symbols or the different sets of modulation symbols in a same second set of time and frequency resources.

### Supplementary Note 38

A method performed by a Distributed Unit (DU) of a base station, the method comprising:
controlling a plurality of transmission points to transmit a first demodulation reference signal used to demodulate a same set or one of different sets of modulation symbols generated from a same broadcast channel payload or from different broadcast channel payloads, in a separate first set of time and frequency resources per transmission point; and
controlling the plurality of transmission points to transmit the same set of modulation symbols or the different sets of modulation symbols in a same second set of time and frequency resources.

This application is based upon and claims the benefit of priority from Japanese Patent Application No. 2022-143672, filed on Sep. 9, 2022, the disclosure of which is incorporated herein in its entirety by reference.

### REFERENCE SIGNS LIST

10 CU
21, 22 DU
31, 32, 33, 34, 35 TRP
40 UE
51, 52, 53 Cell
1602 Processor
1603 Memory
1704 Processor
1705 Memory
1803 Baseband processor
1804 Application processor
1806 Memory

What is claimed is:

1-17. (canceled)

18. A method performed by a transmission system of a base station, the method comprising:
transmitting a first demodulation reference signal used to demodulate a same set or one of different sets of modulation symbols generated from a same broadcast channel payload or from different broadcast channel payloads, from each of a plurality of transmission points, in a separate first set of time and frequency resources per transmission point; and
transmitting the same set of modulation symbols or the different sets of modulation symbols from the plurality of transmission points in a same second set of time and frequency resources.

19. (canceled)

20. A radio terminal comprising:
a radio frequency (RF) circuit configured to communicate with a radio access network; and
at least one processor coupled to the RF circuit and configured to:
control the RF circuit to receive, in a separate first set of time and frequency resources per transmission point, a first demodulation reference signal used to demodulate a same set or one of different sets of modulation symbols generated from a same broadcast channel payload or from different broadcast channel payloads; and
control the RF circuit to receive, in a second set of time and frequency resources common to a plurality of transmission points, the same set of modulation symbols or one of the different sets of modulation symbols.

21-31. (canceled)

32. A method performed by a radio terminal, the method comprising:
receiving, in a separate first set of time and frequency resources per transmission point, a first demodulation reference signal used to demodulate a same set or one of different sets of modulation symbols generated from a same broadcast channel payload or from different broadcast channel payloads; and
receiving, in a second set of time and frequency resources common to a plurality of transmission points, the same set of modulation symbols or one of the different sets of modulation symbols.

33-38. (canceled)

39. The method according to claim 18, wherein the transmitting the same set of modulation symbols or the different sets of modulation symbols comprises transmitting the same set of modulation symbols generated from the same broadcast channel payload in the same second set of time and frequency resources.

40. The method according to claim 18, wherein a location of the dedicated first set of time and frequency resources in a resource grid is associated with identification information of a transmission point.

41. The method according to claim 18, wherein a location of the dedicated first set of time and frequency resources in a resource grid is associated with at least a portion of an identifier or index for distinguishing between a plurality of beams or a plurality of synchronization signal and physical broadcast channel blocks transmitted from the plurality of transmission points.

42. The method according to claim 41, wherein
the identifier or the index is divided into a plurality of fields, and
the plurality of fields includes at least a first field associated with the location of the dedicated first set of time and frequency resources in the resource grid.

43. The method according to claim 42, wherein the plurality of fields further includes at least one of:
a second field carried in the broadcast channel payload;
a third field carried in a sequence of the first demodulation reference signal;
a fourth field carried in a sequence of a second demodulation reference signal transmitted by the plurality of transmission points in a same third set of time and frequency resources; and
a fifth field carried in a sequence of a synchronization signal transmitted by the plurality of transmission points in a same fourth set of time and frequency resources.

44. The method according to claim 18, wherein the first demodulation reference signal has a different sequence per transmission point by being generated based on identification information of a transmission point.

45. The method according to claim 32, wherein
the first demodulation reference signal is used to demodulate the same set of modulation symbols generated from the same broadcast channel payload, and
the receiving the same set of modulation symbols or one of the different sets of modulation symbols comprises receiving the same set of modulation symbols in the common second set of time and frequency resources.

46. The method according to claim 45, further comprising:
estimating an individual channel response between each transmission point and the radio terminal based on the reception of the demodulation reference signal;
calculating a composite channel response using the plurality of individual channel responses between the plurality of transmission points and the radio terminal; and
demodulating the same broadcast channel payload from the same set of modulation symbols using the composite channel response.

47. The method according to claim 32, wherein the at least one processor is configured to identify an identifier or index for distinguishing between a plurality of beams or a plurality of synchronization signal and physical broadcast channel blocks transmitted from the plurality of transmission points, based at least on a location of the dedicated first set of time and frequency resources in a resource grid.

48. The method according to claim 32, further comprising identifying an identifier or index for distinguishing between a plurality of beams or a plurality of synchronization signal and physical broadcast channel blocks transmitted from the plurality of transmission points, based at least on a sequence of the first demodulated reference signal received in the dedicated first set of time and frequency resources.

49. The method according to claim 47, further comprising:
measuring received power or quality in the dedicated first set of time and frequency resources carrying the first demodulation reference signal; and
determining a best beam or a best synchronous signal and physical broadcast channel block based on the received power or received quality and the identifier or index.

50. The method according to claim 47, further comprising:
measuring received power or received quality in the dedicated first set of time and frequency resources carrying the first demodulation reference signal; and
reporting the received power or received quality to the radio access network along with the associated identifier or index.

51. The method according to claim 32, further comprising identifying a total number of transmission points in a cell transmitting in the same second set of time and frequency resources or a total number of beams transmitted in a cell in the same second set of time and frequency resources, based at least on a sequence of a synchronization signal transmitted by the plurality of transmission points in a same set of time and frequency resources.

52. The method according to claim 32, further comprising identifying a total number of transmission points in a cell transmitting in the same second set of time and frequency resources or a total number of beams transmitted in a cell in the same second set of time and frequency resources, based at least on a sequence of a second demodulation reference signal transmitted by the plurality of transmission points in a same set of time and frequency resources.

53. The method according to claim 32, further comprising identifying a total number of transmission points in a cell transmitting in the same second set of time and frequency resources or a total number of beams transmitted in a cell in the same second set of time and frequency resources, based at least on the broadcast channel payload.

54. The method according to claim 32, further comprising identifying a total number of transmission points in a cell transmitting in the same second set of time and frequency resources or a total number of beams transmitted in a cell in the same second set of time and frequency resources, based at least on configuration information within a System Information Block Type 1 (SIB1).

55. The method according to claim 51, further comprising identifying a location of the dedicated first set of time and frequency resources in a resource grid, based on the total number of transmission points in the cell transmitting in the same second set of time and frequency resources or the total number of beams transmitted in the cell in the same second set of time and frequency resources.
